(19) United States
(12) Patent Application Publication
(10) Pub. No.: US 2014/0115571 A1
(43) Pub. Date: Apr. 24, 2014

(54) ELECTRONIC DEVICE, NON-TRANSIENT READABLE MEDIUM AND METHOD THEREOF

(71) Applicants: Zhu-Hong Wang, SINGAPORE (SG); Xuan Wang, SINGAPORE (SG)

(72) Inventors: Zhu-Hong Wang, SINGAPORE (SG); Xuan Wang, SINGAPORE (SG)

(73) Assignee: ASUS TECHNOLOGY PTE LTD., SINGAPORE (SG)

(21) Appl. No.: 13/929,808

(22) Filed: Jun. 28, 2013

(30) Foreign Application Priority Data
Oct. 23, 2012 (CN) 201210406381.4

(51) Int. Cl. G06F 9/445

(52) U.S. Cl. CPC G06F 8/66
USPC 717/168

(57) ABSTRACT

An electronic device, a method for updating firmware, and a non-transient readable medium are provided. The electronic device includes a processing unit and a NVM memory. The NVM memory is coupled to the processing unit. The NVM memory stores the firm. Identifying information is in a non-file-header area of the firmware. The identifying information includes a firmware image file header, a digital signature and ROM map information.

### CROSS-REFERENCE TO RELATED APPLICATION

This application claims the priority benefit of CN application serial NO. 201210406381.4, filed on Oct. 23, 2012. The entirety of the above-mentioned patent application is hereby incorporated via reference herein and made a part of specification.

### BACKGROUND OF THE INVENTION

1. Field of the Invention

The disclosure relates to an electronic device and, more particularly to firmware of the electronic device, a method for updating firmware and a non-transient readable medium storing a firmware image file.

2. Description of the Related Art

The electronic device usually includes firmware to be used as an interface between software and hardware, and the firmware also can store setting values for the hardware. The component for storing the firmware may be a nonvolatile memory (NVM) such as a flash memory. When the hardware of the electronic device needs to be upgraded or updated, the version of the firmware usually needs to be updated, that is, the firmware of new version is recorded to the NVM which is used to store the original firmware.

FIG. 1 is a schematic diagram showing the data structure of a conventional firmware image file. Referring to FIG. 1, the conventional firmware image file 110 (which also may be called as a firmware capsule) is composed of an identifying information (which also may be called as a firmware capsule header) 111 and an actual firmware image 112, and the identifying information 111 includes a capsules header, a digital signature, read only memory (ROM) map information. The capsules header, the digital signature and the ROM map information can be used to check and update the firmware. The identifying information 111 is ahead of the actual firmware image 112. The capsules header, the digital signature, the ROM map information and the actual firmware image 112 are composed to the firmware image file 110 (as shown in FIG. 1) to check and update the firmware conveniently.

The size of the actual firmware image 112 conforms to the actual capacity of a storage memory 120 (such as a flash memory). Since the identifying information 111 is added ahead of the actual firmware image 112 to form the conventional firmware image file 110, the size of the firmware capsule 110 is larger than the actual capacity of the firmware memory 120. When the firmware image 110 is recorded into the NVM, the identifying information 111 of the firmware image 110 must be removed first via the software, and the remainder firmware image (that is the actual firmware image 112) is regarded as the firmware 112′ to be refreshed or recorded into the firmware memory 120.

Since the identifying information 111 (such as the capsules header, the digital signature and the ROM map information) is removed or discarded, the firmware 112′ recorded into the firmware memory 120 does not include the identifying information to check and update the firmware. The firmware 112′ read from the firmware memory 120 cannot be used for firmware rollback or firmware recovery.

Since the identifying information is added ahead of the actual firmware file to form the conventional firmware file, the size of the conventional firmware file is larger than the actual capacity of the firmware memory, and the conventional firmware file cannot be recorded completely into the firmware memory directly via a common integrated circuit (IC) writer.

### BRIEF SUMMARY OF THE INVENTION

An electronic device is provided, the electronic device includes firmware, and identifying information of the firmware is packed in a non-file-header area of the firmware, that is, the area which is in the firmware but not the file header.

A non-transient readable medium is provided, the non-transient readable medium stores a firmware image file and the identifying information of the firmware image is packed at the non-file-head area of the firmware image.

A method of updating the firmware is provided, and it determines whether the identifying information in the firmware image file is effective, and the electronic device access the firmware image file to update the firmware.

An electronic device is provided in an embodiment, the electronic device includes a processing unit and a NVM. The NVM is coupled to the processing unit and stores the firmware image file.

The firmware image file includes identifying information, and the identifying information is packed in the non-file-header area of the firmware image file. The identifying information includes one or a combination of a firmware image file header, a digital signature, and ROM map information.

A method for updating the firmware is provided, and the NVM of the electronic device stores the firmware image file to update the electronic device. The method includes providing the firmware image file. The identifying information of the firmware image file is packed in the non-file-header area of the firmware image file, and the size of the firmware image file conforms to the capacity of the NVM storing the firmware in the electronic device. The identifying information is composed of one or a combination of the firmware image file header, the digital signature and the ROM map information. In updating, extracting the identifying information from the non-file-header area of the firmware image file and checking the firmware image file according to the identifying information to determine that whether the firmware image file is effective. When the firmware image file is effective, updating the electronic device via the firmware image file.

In one embodiment, the identifying information includes a address flag, the processing unit captures the identifying information from the firmware image file according to the address flag and the identifying information is regarded as the data of a firmware capsule header.

In another embodiment, the firmware image file includes a plurality of unsigned areas, and the identifying information is packed in one of the unsigned areas via the processing unit.

In sum up, one or a combination of the firmware image header, the digital signature and the ROM map information is packed in the non-file-header area of the actual firmware image file. The digital signature is packed in an area which may be in the middle of the actual firmware image file but not the file header. The size of the firmware image file (or the firmware) conforms to the capacity of the NVM. A recorder records the firmware image file with the identifying information to the NVM. In updating the firmware, the identifying information (such as the firmware image file header, the digital signature, the ROM map information) of the firmware image file is extracted according to a particular flag or a constant area, and then the identifying information is combined with the firmware image file to form a firmware capsule to be used to check and update.

### BRIEF DESCRIPTION OF THE DRAWINGS

FIG. 1 is a schematic diagram showing the data structure of a conventional firmware image file.

FIG. 2 is a schematic diagram showing that the firmware image file is recorded to a nonvolatile memory in an embodiment of the disclosure.

FIG. 3 is a flowchart showing a method of updating firmware in an embodiment of the disclosure.

FIG. 4 and FIG. 5 are schematic diagrams showing firmware image files in different embodiments.

### DETAILED DESCRIPTION OF THE EMBODIMENTS

When an electronic device accesses firmware, if whether the firmware conforms to the setting in the electronic device can be determined, the risk that the electronic device is abnormal due to the access of the incompatible firmware is avoided, and it is more convenient for the user to update or record the firmware. The disclosure will become better understood with regard to the following description about some embodiments.

FIG. 2 is a schematic diagram showing that the firmware image file is recorded to a NVM 210. An electronic device 200 may be a smartphone, a tablet computer, a notebook computer or any other electronic device capable of storing the firmware. The electronic device 200 includes a NVM 210 and a processing unit 250.

Referring to FIG. 2, according to various applying situations, the firmware image file 300 can be stored in a non-transient readable medium (such as a digital video disk, a removable disk and a memory card) or a remote server. Thus, the firmware image file 300 can be read from the removable memory by a local reading device, and the firmware image file 300 also can be obtained from the remote server via the communication network (such as Internet or local area network).

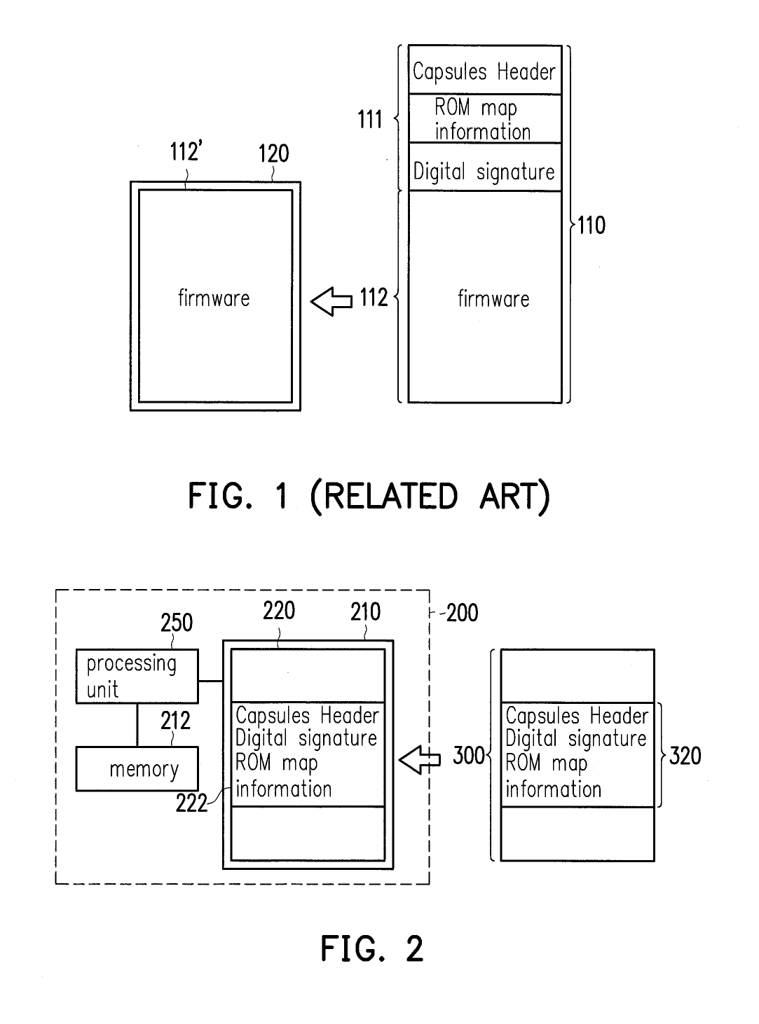

An actual image 112 of a conventional firmware image file 110 in FIG. 1 does not include a capsules header, a digital signature, ROM map information or any other identifying information therein. Unlike the conventional firmware file 110, the identifying information 320 (such as one or a combination of the capsules header, the image file header, the digital signature and the ROM map information) is packed in a non-file-header area of the actual firmware image (that is the firmware image file 300). The non-file-header area is an area of the actual firmware image but not at the file header. For example, the firmware image file 300 includes a plurality of unsigned areas, and the identifying information 320 in the firmware image file 300 is packed in one of the unsigned areas. The image file header (or the capsules header), the digital signature and/or the ROM map information in the firmware image file 300 can be used to check and/or update the firmware.

Since the size of the firmware image file 300 conforms to the capacity of the nonvolatile memory 210, the whole firmware image file 300 can be directly recorded to the actual firmware of the nonvolatile memory 210. In recording the firmware image file 300 to the NVM 210, the identifying information 320 does not need to be removed, and the whole firmware image file 300 is updated or recorded to the NVM 210 to be regarded as the firmware 220. After the recording, the firmware 220 includes the identifying information 222, and the identifying information 222 is in accordance with the identifying information 320. Moreover, since the firmware 220 in the NVM 210 includes the identifying information 222 (such as the image file header/the capsules header, the digital signature and/or the ROM map information), the identifying information 222 recorded to the nonvolatile memory 210 can be used to check and/or update the firmware. The firmware 220 read from the nonvolatile memory 210 via software also can be used for the firmware rollback or firmware recovery.

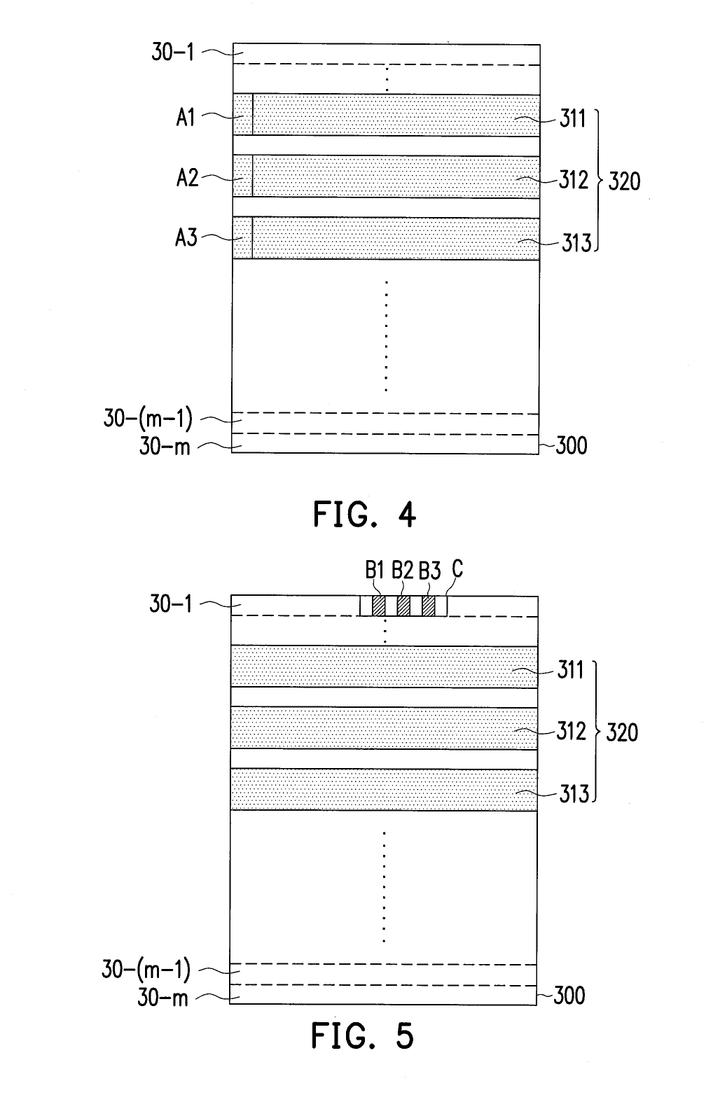

Referring to FIG. 2, the NVM 210 may be a ROM or a flash memory. The NVM 210 is used to store the firmware 220. The firmware 220 may be a basic input or output system (BIOS), an extensible firmware interface (EFI) BIOS or a unified extensible firmware interface (UEFI) BIOS, which is not limited herein. Furthermore, the firmware 220 includes identifying information 222, and the identifying information 222 is used to check whether the firmware 220 is effective. The identifying information 222 in the firmware 220 includes one or a combination of the image file header/the capsules header of the firmware 220, the digital signature and the ROM map information. The firmware 220, the identifying information 222 in FIG. 2 can be analogized referring to the following descriptions of the firmware image file 300 and the identifying information 320 in FIG. 4 and FIG. 5.

The processing unit 250 is coupled to the NVM 210, the processing unit 250 may be a central processing unit (CPU) and/or a chipset to be used to execute the data of the firmware and process the data in the software of the electronic device 200. In this embodiment, when the electronic device 200 obtains the firmware image file 300 used to update the firmware 220, the processing unit 250 can update the firmware 220 according to the firmware image file 300. In another embodiments, the firmware image file 300 obtained by the electronic device 200 can be stored in the non-transient readable medium (such as a memory 212), and the processing unit 250 can access the firmware image file 300 to update the firmware 220. The memory 212 may be a random access memory (RAM), an optical disk and a portable disk, the processing unit 250 can access the firmware image file 300 via the memory 212 to update the firmware 220.

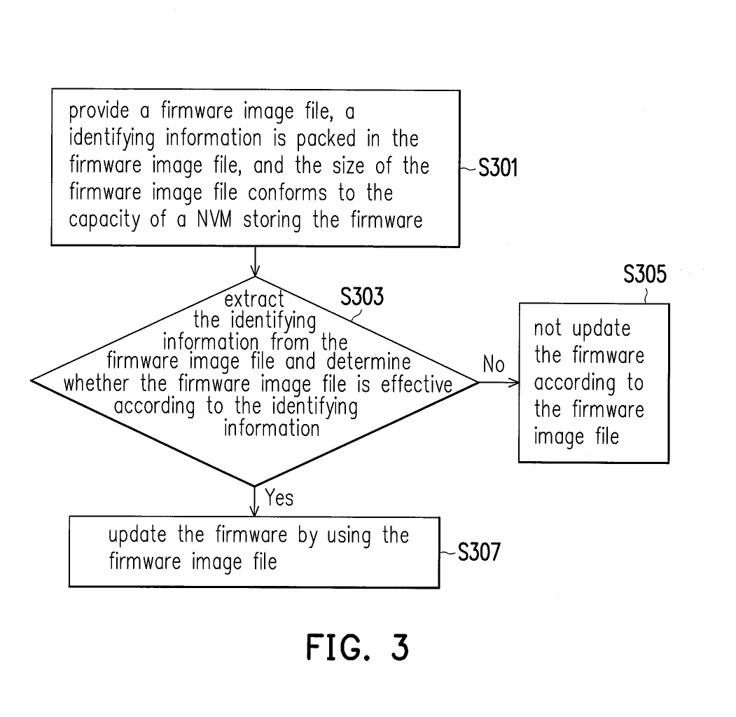

FIG. 3 is a flowchart showing a method for updating the firmware in an embodiment. The method for updating the firmware is used to update the firmware 220 of the electronic device 200.

Referring to FIG. 1 and FIG. 2, when the electronic device 200 obtains the firmware image file 300 with the identifying information, as shown in step S301, the processing unit 250 of the electronic device 200 extracts the identifying information 320 from the non-file-header area of the firmware image file 300. The size of the firmware image file 300 conforms to the capacity of the NVM 210, and thus the processing unit 250 can store the whole firmware image file 300 into the NVM 210. That is, the firmware image file 300 in this embodiment includes identifying information 320, and the identifying information 320 is packed in the firmware image file 300. Thus, when the electronic device 200 accesses the firmware image file 300, the size of the firmware image file 300 conforms to the capacity of the NVM 210 which is used for storing the firmware image file 300, and the NVM 210 of the electronic device 200 can record the firmware image file 300 normally and completely. Additionally, the identifying information 320 of the firmware image file 300 includes the data to identify the firmware image file 300, and the data may be the information (such as the image file header, the digital signature, the ROM map information and other parameters for updating the firmware 220) needed to update the electronic device 200.

FIG. 4 and FIG. 5 are schematic diagrams showing the firmware image files in different embodiments. The firmware image file 300 and the identifying information 320 in FIG. 2 can be analogized referring to the descriptions of the firmware image file 300 and the identifying information 320 in FIG. 4 and FIG 5. Referring to FIG. 4, the identifying information 320 of the firmware image file 300 is packed in at least one of the unsigned areas of the firmware image file 300. The firmware image file 300 can be divided into m areas 30-1 to 30-m, “M” is a positive integer, and some areas of the areas 30-1 to 30-m may be unsigned areas. The unsigned areas of the areas 30-1 to 30-m may not include effective firmware codes. Thus, the identifying information 320 of the firmware image file 300 can be packed into at least one of the unsigned areas of the areas 30-1 to 30-m.

The identifying information 320 includes a plurality of updating information 311, 312 and 313. The updating information 311 to 313 can be one or a combination of the image file header/the capsule header, the digital header, the ROM map information or other identifying information for updating the firmware 220. In this embodiment, the updating information 311 includes the image file header (or the capsules header), the updating information 312 includes the digital signature, and the updating information 313 includes the ROM map information, which is not limited herein. The updating information 311 to 313 includes address flags A1 to A3, and the processing unit 150 extracts the identifying information 320 according to the address flags A1 to A3. When the processing unit 150 gradually accesses the data in the areas 30-1 to 30-m, if the areas with address flags A1 to A3 are accessed, the processing unit 150 can determine that the accessed areas are the locations of the identifying information 311 to 313.

In another embodiment, referring to FIG. 5, the location information of the updating information 311 to 313 can be stored in one of the areas 30-1 to 30-m to allow the processing unit 250 to get the updating information 311 to 313 according to the location information (index information). If a specific area C of the area 30-1 record the location B1 to B3 of the updating information 311 to 313 in the firmware image file 300, when the processing unit 250 access the specific area C, the updating information 311 to 313 can be extracted via the location B1 to B3 recorded in the specific area.

Referring to FIG. 2, FIG. 3 and FIG. 4, in step S303, the processing unit 250 extracts the identifying information 320 from the firmware image file 300 and checks the firmware image file 300 according to the identifying information 320 to determine whether the firmware image file 300 is effective. Since the updating information 311 to 313 in the firmware image file 300 includes specific address flags A1 to A3, the processing unit 250 can obtain the data of the updating information 311 to 313 according to the address flags A1 to A3, and it combines the data of the updating information 311 to 313 (that is the image file header, the digital signature and the ROM map information) to be used as the data of the firmware capsule header of the firmware image file 300.

After the processing unit 250 extracts the identifying information 320 in the firmware image file 300 according to the location lag A1 to A3, the processing unit 250 compares the identifying information 320 in the firmware image file 300 to the identifying information 222 in the firmware 220 and determines whether the firmware image file 300 is effective. In this embodiment, the processing unit 250 determines whether the firmware image file 300 conforms to the identifying information 222 according to the digital signature (that is the updating information 312) in the identifying information 320, and the digital signature may include the version information of the firmware image file 300. Thus, when the digital signature of the firmware image file 300 conforms to the edition information of the identifying information 222, the processing unit 250 determines that whether the firmware image file 300 conforms to the electronic device 200, and then it can determine whether the firmware image file 300 is effective. Conversely, when the identifying information 320 of the firmware image file 300 does not conform to the identifying information 222 of the firmware 220, the processing unit 250 determines that the firmware image file 300 is ineffective.

When the processing unit 250 determines that the firmware image file 300 is ineffective, as shown in step S305, the processing unit 250 does not update the firmware 220 according to the firmware image file 300. Moreover, the processing unit 250 sends out a warning signal. For example, the warning information is displayed to inform the user that the firmware image file 300 does not conform to the electronic device 200.

When the processing unit 250 determines that the firmware image file 300 is effective, as shown in step S307, the processing unit 250 uses the firmware image file 300 to update the firmware 220. The processing unit 250 stores the original (before updating) firmware 220 to another nonvolatile memory (not shown) and update the firmware 220 via the firmware image file. Since the firmware 220 before the updating includes the identifying information 222, when the user is not satisfied with the edition of the updated firmware 220 (that is the firmware image file 300), the processing unit 250 can identify the firmware 220 before the updating according to the identifying information 222 of the firmware 220 before the updating. The processing unit 250 can also store the identifying information 222 of the original firmware 220 into the updated firmware 220. Thus, when the user is not satisfied with the edition of the updated firmware 220, the processing unit 250 can load the edition of the corresponding firmware from the internet according to the identifying information 222 of the firmware 220 before updating. Consequently, the user can select the edition of the updated firmware or the edition of the firmware before the firmware is updated.

Based on above, the processing unit 250 can determine whether the firmware image file 300 is effective according to the identifying information 222 in the firmware image file 300. The electronic device 200 can access the compatible firmware image file to update the original firmware 222, and the user can use the updated effectively firmware.

Additionally, the processing unit 250 can check the firmware 200 to determine whether the firmware 200 is effective according to the identifying information 222 in the firmware 220. For example, the processing unit 250 can determine whether the firmware 220 is modified illegally according to the identifying information 222 in the firmware 220 (for example the firmware 220 is updated illegally by the computer virus or the contents in the firmware 220 is damaged).

If the firmware 220 of the NVM 210 is modified illegally, the content in the firmware 220 would not conform to the identifying information 222. In this embodiment, the processing unit 250 can determine whether the firmware 220 is modified illegally by checking the digital signature of the identifying information 222. For example, since the digital signature is generated according to the contents in the firmware 220, if the firmware 220 is modified illegally, the content in the firmware 220 does not conform to the original firmware 220. Consequently, when the identifying information 222 extracted via the processing unit 250 does not conform to the content in the firmware 120, the processing unit 250 determines that the firmware 220 is ineffective. If the processing unit 250 determines that the firmware 220 is ineffective, the processing unit 250 sends out a warning signal via the display unit (not shown). For example, the warning is displayed to inform the user, and the access of data in the firmware is stopped. If the processing unit 250 determines that the firmware 220 is effective, the processing unit 250 does not send out the warning via the display unit.

In other words, when the processing unit 250 accesses data in the firmware 220 (for example, when recording the firmware 220), the processing unit 250 determines whether the firmware 220 is modified and whether the firmware 220 is effective according to the identifying information 222 of the firmware 220. When the firmware 220 is ineffective, the processing unit 250 informs the user immediately. The electronic device 200 can access the compatible firmware to facilitate the user using and maintaining the firmware 220 in the NVM 210.

In sum up, the firmware of the electronic device, the non-transient readable medium storing the firmware image file and the method of updating the firmware are provided. Conventionally, since the identifying information is added ahead of the actual firmware image to form the conventional firmware file, the size of the conventional firmware file is larger than the actual capacity of the firmware memory, and the traditional firmware file cannot be recorded to the firmware memory via the common IC writer. In above embodiments of the disclosure, one or a combination of the image file header, the digital signature, the ROM map information is packed in the area which is in the firmware image file but not at the file header. Thus, the size of the firmware image file (or the firmware) conforms to the capacity of the firmware memory. Moreover, since the firmware image file (or the firmware) includes the identifying information, the processing unit of the electronic device can determine whether the identifying information is effective and then update the firmware. Additionally, the processing unit of the electronic device can protect the firmware by determining whether the identifying information of the firmware is effective. Consequently, the electronic device can execute the effective firmware to make the user use the correct edition of the new firmware or maintain the edition of the original firmware.

Although the disclosure has been described in considerable detail with reference to certain preferred embodiments thereof, the disclosure is not for limiting the scope. Persons having ordinary skill in the art may make various modifications and changes without departing from the scope. Therefore, the scope of the appended claims should not be limited to the description of the preferred embodiments described above.

What is claimed is:

1. An electronic device, comprising:
a processing unit; and
a nonvolatile memory (NVM) coupled to the processing unit;
wherein the nonvolatile memory stores a firmware image file, the firmware image file includes identifying information, the identifying information is packed at a non-file-header area of the firmware image file, and the identifying information includes one or a combination of a firmware image file header, a digital signature and read only memory (ROM) map information.

2. The electronic device according to claim 1, wherein when firmware needs to be updated, the electronic device extracts the identifying information from the non-file-header area of the firmware image file;
the electronic device checks the firmware image file according to the identifying information of the firmware image file to determine whether the firmware image file is effective; and
the electronic device updates the firmware via the firmware image file when the firmware image file is effective.

3. The electronic device according to claim 1, wherein the firmware image file includes a plurality of unsigned areas and the identifying information of the firmware image file is packed in one of the unsigned areas.

4. The electronic device according to claim 1, wherein the size of the firmware image file conforms to the capacity of the nonvolatile memory.

5. The electronic device according to claim 1, wherein the identifying information further includes a address flag, the processing unit obtains the identifying information from the firmware image file according to the address flag, and the identifying information is regarded as data of a firmware capsule header of the firmware image file.

6. A non-transient readable medium, wherein the non-transient readable medium stores a firmware image file, identifying information of the firmware image file is packed in an area which is in the firmware image file but not at a file header, the identifying information includes one or a combination of a firmware image file header, a digital signature and ROM map information.

7. A method for updating firmware, wherein a NVM of an electronic device stores a firmware image file to update the electronic device, the method comprising:
providing the firmware image file, wherein identifying information of the firmware image file is packed in a non-file-header area of the firmware image file, the size of the firmware image file conforms to the capacity of the NVM for storing the firmware, and the identifying information includes one or a combination of a firmware image file header, a digital signature and ROM map information;
extracting the identifying information from the non-file-header area of the firmware image file in updating the firmware, and checking the firmware image file according to the identifying information to determine whether the firmware image file is effective; and
updating the electronic device by using the firmware image file if the firmware image file is effective.

8. The method for updating the firmware according to claim 7, wherein the identifying information further includes a address flag.

9. The method for updating the firmware according to claim 8, wherein the step of extracting the identifying information from the firmware image file includes:
obtaining the identifying information from the firmware image file according to the address flag; and
regarding the identifying information as data of a firmware capsule header of the firmware image file.

10. The method for updating the firmware according to claim 7, wherein the firmware image file includes a plurality of unsigned areas and the identifying information is packed in one of the unsigned areas.

11. The method for updating the firmware according to claim 7, wherein the firmware stored in the NVM includes the identifying information and the identifying information includes one or a combination of the firmware image file header, the digital signature and the ROM map information.

12. The method for updating the firmware according to claim 11, wherein the step of updating the firmware by using the firmware image file includes:
comparing the firmware image file to the identifying information to determine whether the firmware image file is effective; and
updating the firmware in the NVM via the firmware image file when the firmware image file is effective.

13. The method for updating the firmware according to claim 11 further comprising:
checking the firmware to determine whether the firm is effective.
